(19) United States
(12) Patent Application Publication
(10) Pub. No.: US 2006/0106667 A1
(43) Pub. Date: May 18, 2006

(54) System and method for determining compatibility

(76) Inventor: Christopher R. Coyne, New York, NY (US)

Correspondence Address: FROMMER LAWRENCE & HAUG, 745 FIFTH AVENUE- 10TH FL., NEW YORK, NY, 10151, US

(21) Appl. No.: 10/991,974

(22) Filed: Nov. 18, 2004

(51) Int. Cl. G06F 17/30

(52) U.S. Cl. 705/10

(57) ABSTRACT

A system and method for generating an indication of compatibility between individuals and groups includes accessing first response data from a first user as well as desired first response data from the first user. A first weighing factor is associated with each of the desired first response data. Second response data from a second user is accessed as well as desired second response data from the second user. A second weighing factor is associated with each of the desired second response data. Indicator data is generated as a function of the first response data, first desired response data, first weighing factor, the second response data, the second desired response data, and the second weighing factor. This indicator data can be modified as a function of a margin of error, importance of particular questions and other essential criteria, such as gender, age and religion. A ranking process ranks users based on their relative compatibility.

### BACKGROUND

1. Field of the Invention

This invention relates generally to determining compatibility between individuals as well as between individuals and groups or institutions. More particularly, the present invention relates to determining compatibility based on desired responses to particular questions and a weighing factor associated with each desired response.

2. Background Discussion

Generally, matchmaking is an attempt to match individuals who are expected to be compatible, at least at some level. Since the wide-scale availability of the Internet, network matchmaking has become increasingly popular due to its convenience and ability to overcome demographic, distance and cultural issues that can make it difficult for like-minded people to meet. Therefore, it is desirable to have a readily accessible, widely available system that helps people meet each other.

Most conventional approaches to determining compatibility (i.e., matchmaking) typically involve a questionnaire to which a user provides answers. These answers are then compared to answers from other users to attempt to determine a “match” (i.e., that two individuals will be compatible, at least at some level) using some type of matching algorithm.

Some conventional matching algorithms base compatibility scores on either (a) similarity of responses or (b) psychological profiles and sociological data of other couples that have had successful relationships. However, neither of these approaches is completely satisfactory.

Matching algorithms based on similarity of responses assume, possibly incorrectly, that individuals who are similar to one another are likely to be compatible in a romantic, or other, relationship. However, common sense suggests that this oversimplification is unrealistic. Secondly, matching people based on psychological profiles and sociological data of other couples that have had successful relationships is based on the underlying assumption, which is not necessarily correct, that two “types” of people that make a good match under one set of circumstances will be likely to make a good match generally.

Other conventional approaches obtain personal preferences for a user as search criteria. The personal preferences include, for example: a gender preference; a geographic location preference; an age preference; appearance preferences; religious belief preferences; educational level preferences; and a goal preference. Compatibility is determined based on these preferences.

Still other conventional approaches to matchmaking attempt to select a set of values and have entities such as individuals or organizations rate each value. The ratings of users are compared in an attempt to determine compatibility.

Unfortunately, conventional compatibility determining methods do not provide a desired level of accuracy for the users. Thus, it would be an advancement in the state of the art to enable users to improve the likelihood that they will be matched with a compatible individual or group.

### BRIEF SUMMARY OF THE INVENTION

The present invention provides a system and method that improves the likelihood that a user will be matched to an individual or group that meets or exceeds a compatibility requirement of the user. This is accomplished by determining how a user answers a question, how a user would like a compatible person to answer the question and a weighing factor that indicates the importance, or significance, of the question. Responses from other users are compared and an indication of compatibility is computed for each user with the other users.

Accordingly, one embodiment of the present invention is directed to a system and method for generating an indication of compatibility that includes accessing first response data from a first user as well as desired first response data from the first user. A first weighing factor is associated with each of the desired first response data. Second response data, from a second user, is accessed as well as desired second response data from the second user. A weighing factor is associated with each of the desired second response data. Indicator data is generated as a function of the first response data, first desired response data, first weighing factor, the second response data, the second desired response data, and the second weighing factor.

Another embodiment of the present invention is directed to a system and method for generating an indication of compatibility that includes providing a user interface to a user that is adapted to receive first response data from a first user as well as desired first response data from the first user. A first weighing factor is also provided from the first user. Indicator data that is a function of the first response data, first desired response data, the first weighing factor, second response data, second desired response data, and second weighing factor is received at a user location.

Yet another embodiment utilizes a user profile, which includes passively obtained information about the user, to determine the compatibility indicator data.

Yet other embodiments are directed to storing, transmitting, sorting and manipulating the compatibility indicator data that has been generated as described above.

### BRIEF DESCRIPTION OF THE DRAWINGS

FIG. 1 shows a network environment adapted to support the present invention.

FIG. 2 illustrates a processing apparatus adapted to store and process data related to the present invention.

FIG. 3 illustrates a communication appliance shown in FIG. 1.

FIG. 4 illustrates a data table used to store data related to a first user.

FIG. 5 illustrates a data table used to store data related to a second user.

FIG. 6 illustrates a table used to store compatibility indication data.

FIGS. 7A and 7B show one example of an algorithm used to generate the compatibility indication data.

FIG. 8 illustrates a table used to generate user profile data of a user.

FIG. 9 shows an algorithm to generate compatibility indication data at a user location.

FIG. 10 shows a diagram of questions used as a basis of the compatibility indication data.

### DETAILED DESCRIPTION OF THE INVENTION

The present invention provides a system and method to match two individuals, or an individual and a group based on responses to questions. This measure of compatibility can be used to determine match percentages of a potential dating relationship, as well as used to match partners in virtually any forum, such as students to universities, employees to employers, roommates, pet owners to pets and members to groups of interest, such as a hobby group, political action group or civic group.

The present invention is an advancement in the state of the art because rather than (a) matching on similarity or (b) matching on profile compatibility, the present invention allows users to specify weightings of various factors in a match calculation as well as the specific response to a question stem, regardless of whether the desired response is similar or dissimilar to his/her own response to a given question stem. The capability to assign a weighted input into a match formula as well as the ability to specify both a user's own response as well as a desired response improves the likelihood that a determined compatibility indicator will reflect actual compatibility.

The result of the determined compatibility quantifies, between any pair of users, compatibility indication data, such as a compatibility index, also referred as a match percentage, or match ratio. Two users with a high match percentage are, according to their own stated preferences, likely to meet each other's requirements of a desired partner, group or institution.

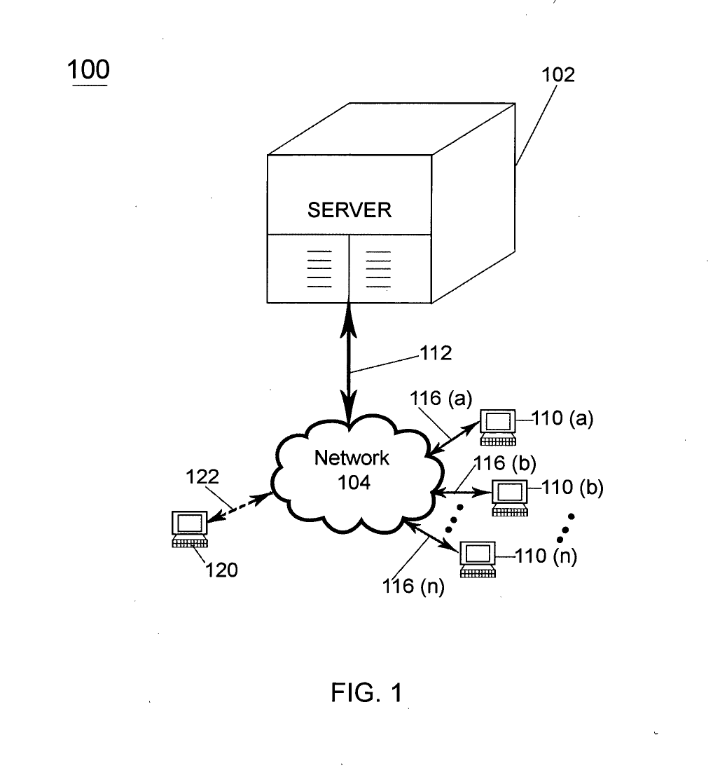

FIG. 1 shows a network environment 100 adapted to support the present invention. The exemplary environment 100 includes a network 104, a server 102, a plurality of communication appliances, or user locations, or subscriber devices, or client terminals, 110(a) . . . (n) (where “n” is any suitable number) (collectively referred to herein as, client terminals 110) and one or more remote client terminals, represented by terminal 120.

The network 104 is, for example, any combination of linked computers, or processing devices, adapted to transfer and process data. The network 104 may be private Internet Protocol (IP) networks, as well as public IP networks, such as the Internet that can utilize World Wide Web (www) browsing functionality.

Server 102 is operatively connected to network 104, via bidirectional communication channel, or interconnector, 112, which may be for example a serial bus such as IEEE 1394, or other wire or wireless transmission medium. The terms “operatively connected” and “operatively coupled”, as used herein, mean that the elements so connected or coupled are adapted to transmit and receive data, or otherwise communicate. The transmission, reception or communication is between the particular elements, and may or may not include other intermediary elements. This connection/coupling may or may not involve additional transmission media or components, and may be within a single module or device or between one or more remote modules or devices.

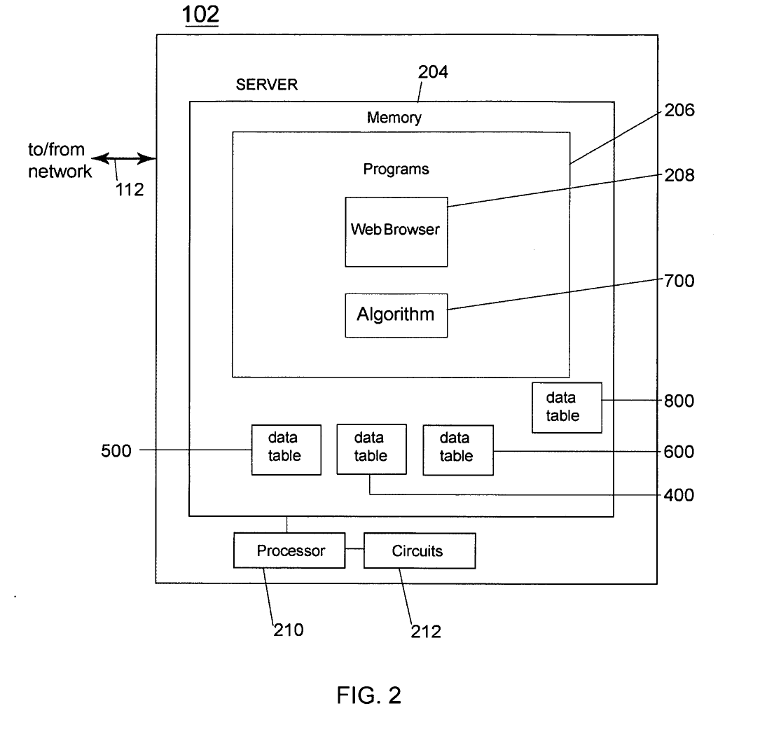

The server 102 is adapted to transmit data to, and receive data from, client terminals 110 and 120, via the network 104. Server 102 is described in more detail with reference to FIG. 2, herein.

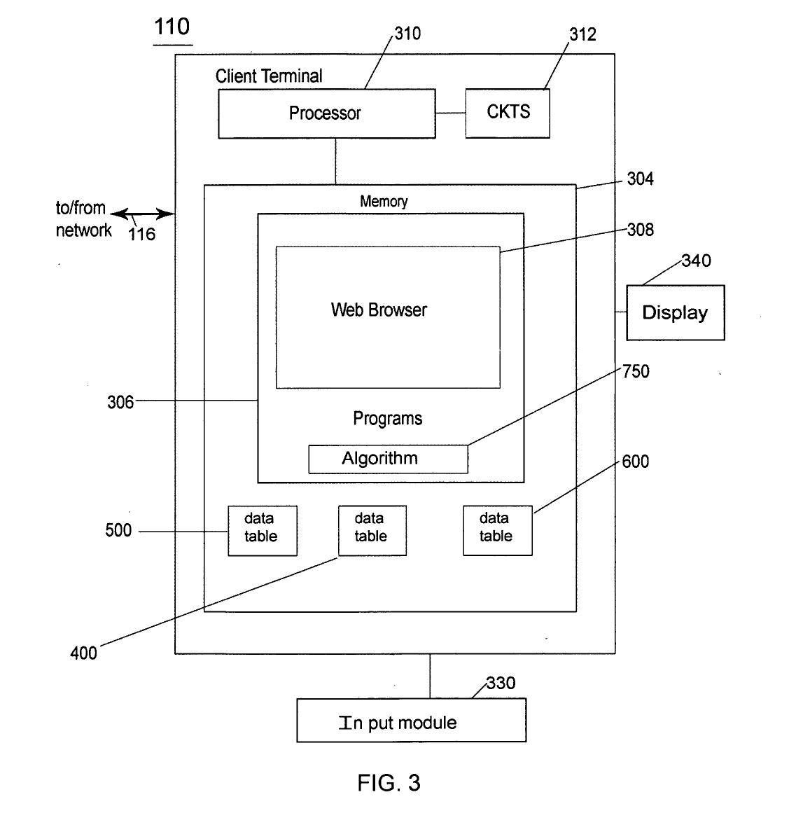

Client terminals 110 and 120 are typically computers, or other processing devices such as a desktop computer, laptop computer, personal digital assistant (PDA), wireless handheld device, and the like. They may be capable of processing and storing data themselves or merely capable of accessing processed and stored data from another location (i.e., both thin and fat terminals). These client terminals 110, 120 are operatively connected to network 104, via bi-directional communication channels 116, 122, respectively, which may be for example a serial bus such as IEEE 1394, or other wire or wireless transmission medium. Client terminals 110, 120 are described in more detail in relation to FIG. 3.

The server 102 and client terminals 110, 120 typically utilize a network service provider, such as an Internet Service Provider (ISP) or Application Service Provider (ASP) (ISP and ASP are not shown) to access resources of the network 104.

FIG. 2 illustrates that server 102, which is adapted to store and process data related to the present invention, is operatively connected to the network (shown as 104 in FIG. 1), via interconnector 112. Server 102 includes a memory 204, processor 210 and circuits 212.

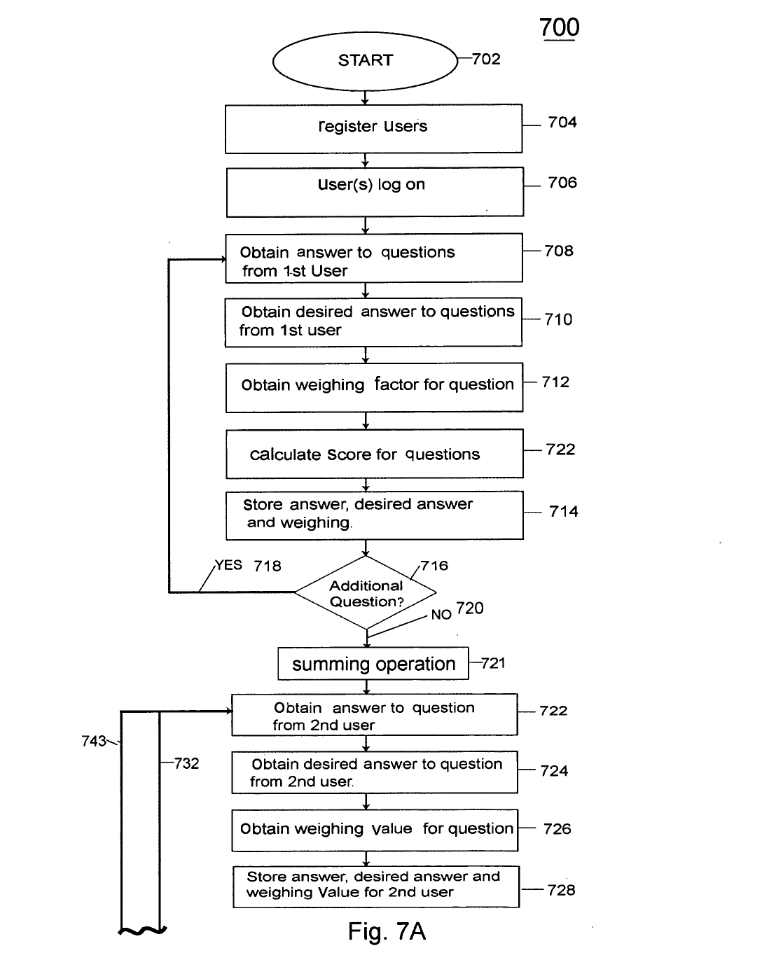

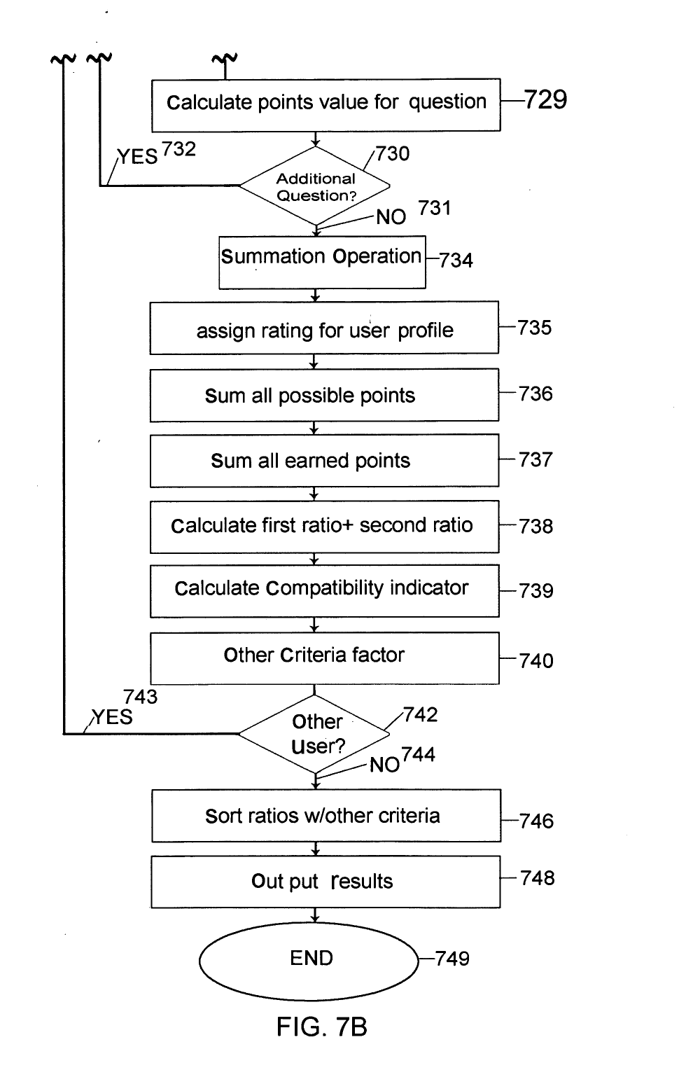

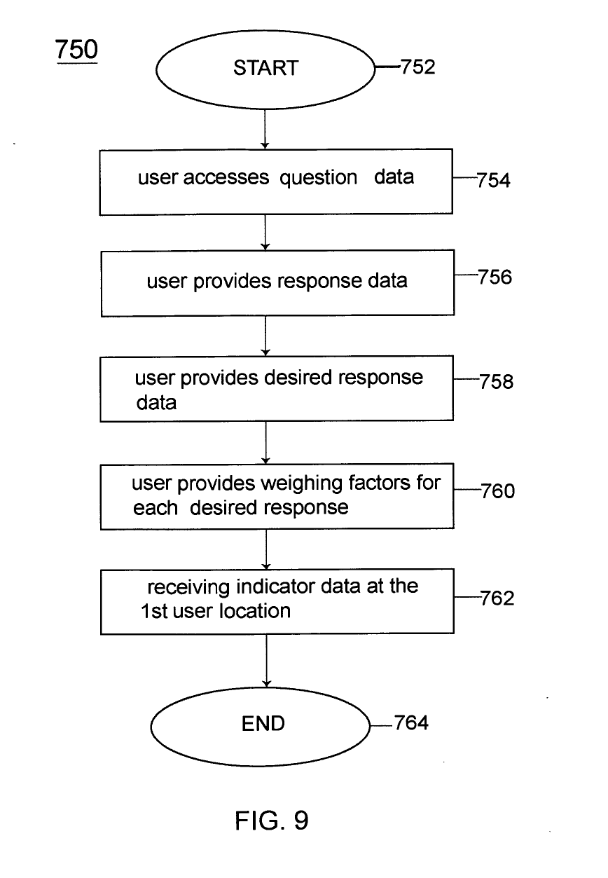

Memory 204 stores programs 206, which include, for example, a web browser 208, a matching algorithm 700, as well as typical operating system programs (not shown), input/output programs (not shown), and other programs that facilitate operation of server 102. Web browser 208 is for example an Internet browser program such as Explorer™. Matching algorithm 700 is a series of steps, typically stored on a computer-readable memory and executed by a processor to calculate a compatibility indication, or indicator data. This algorithm 700 is discussed in more detail in relation to FIGS. 7 and 9.

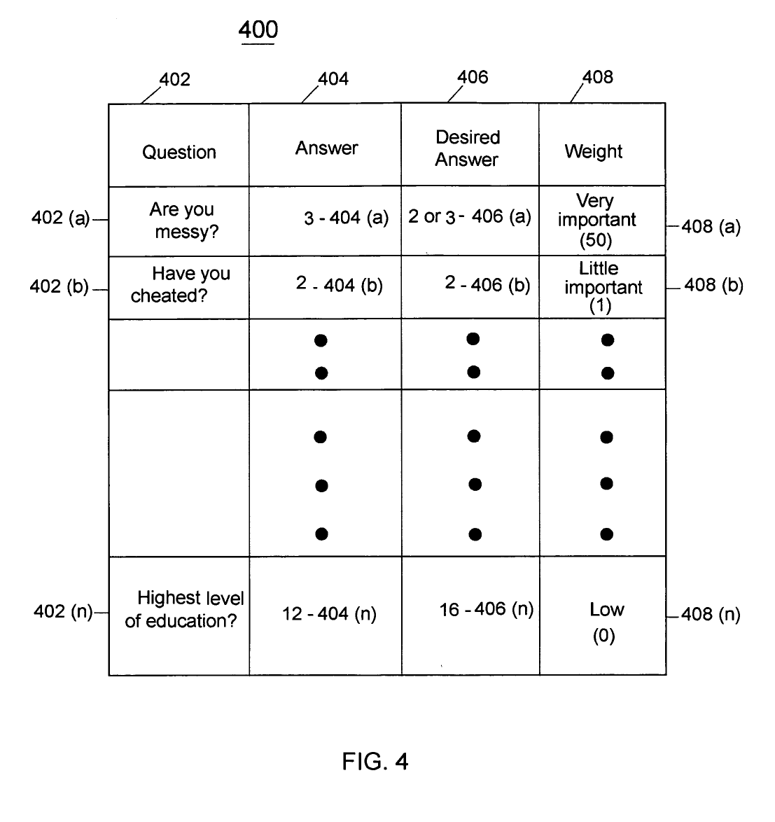

Memory 204 also stores data tables 400, 500, 600 and 800. These data tables 400, 500 600 and 800 are databases or memory locations adapted to store related data, which can be retrieved, processed, updated, modified or otherwise manipulated. Data table 400 is adapted to store questions that are presented to a first subscriber, or user. The first user provides answers to the questions, as well as a desired answer representing how they would like another person, group or institution to answer the question as well as a weighing factor, that represents how important the desired answer is. Data table 400 is discussed in more detail in relation to FIG. 4.

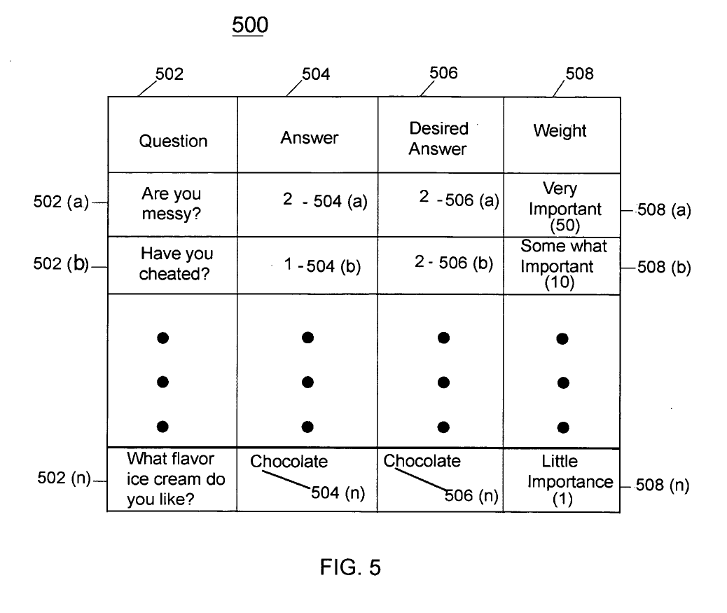

Memory 204 also includes data table 500, which is adapted to store questions, answers, desired answers and a weighing factor for each desired answer from a second user, subscriber, group or institution. Data table 500 is discussed in more detail in relation to FIG. 5.

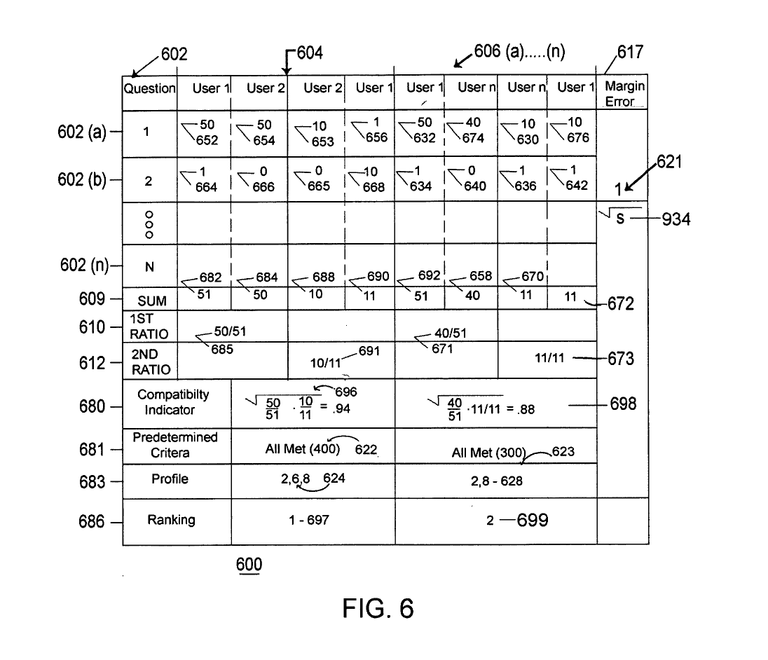

Data table 600 is a memory location that stores compatibility results as a function of processing the data stored in data tables 400 and 500 and, optionally, data table 800. Data table 600 is discussed in more detail in relation to FIG. 6.

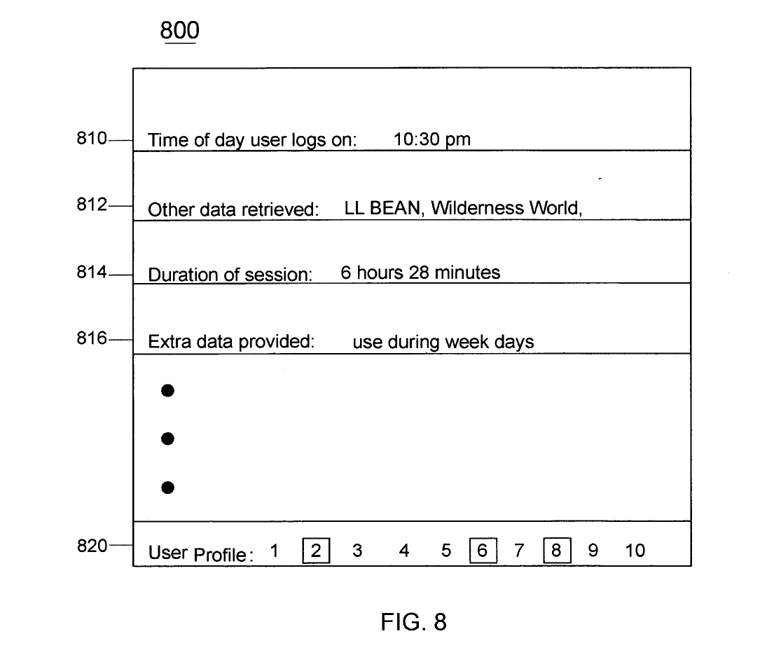

Data table 800 stores additional identifying information about one or more users. Typically, the data stored in data table 800 is obtained passively and represents characteristics based on user preferences as determined by their activity on the network. Data table 800 is discussed in more detail in relation to FIG. 8.

Processor 210, which is operatively connected to memory 204, is used to process and manipulate the data retrieved and stored by server 102. The processor is typically a microprocessor with sufficient speed to adequately performed the desired data manipulations of server 102. Circuits 212 are operatively connected to processor 210 and typically include, for example, Integrated Circuits (ICs), ASICs (application specific ICs) power supplies, clock circuits, cache memory and the like, as well as other circuit components that assist in executing the software routines stored in the memory 204 and that facilitate the operation of processor 210.

FIG. 3 illustrates subscriber terminal, also referred to herein as a client terminal, user terminal, or communication appliance 110. Terminal 110 is typically a desktop computer, laptop computer, PDA (personal digital assistant), wireless handheld device, mobile phone or other device capable of interfacing with a network, such as an IP network. Terminal 110 includes processor 310, support circuitry 312, memory 304, input module 330 and display module 340. Bi-directional interconnection medium 116 operatively connects the terminal 110 to the network (shown as element 104 in FIG. 1).

Processor 310, which is operatively connected to memory 304, is used to process and manipulate the data retrieved and stored by terminal 110. The processor is typically a microprocessor with sufficient speed and processing capacity. The processor 310 is operatively connected to circuitry 312. Circuitry 312 typically includes, for example, Integrated Circuits (ICs), ASICs (application specific ICs) power supplies, clock circuits, cache memory and the like, as well as other circuit components that assist in executing the software routines stored in the memory 304 and that facilitate the operation of processor 310.

Memory 304 stores programs 306, which include, for example, a web browser 308, a matching algorithm 750 as well as typical operating system programs (not shown), input/output programs (not shown), and other programs that facilitate operation of terminal 110. Web browser 308 is for example an Internet browser program such as Explorer™. Matching algorithm 750 is a series of steps, typically executed by a processor such as, for example, processor 310, to calculate a compatibility indication, or indicator data. Matching algorithm 750 is executable at terminal 110. Algorithm 750 is typically used when a portion of the processing described in relation to server 102 is performed at the terminal 110. Algorithm 750 is discussed in more detail in relation to FIG. 9.

Memory 304 also stores data tables 400, 500, and 600. Data tables 400, 500 and 600 are databases or memory locations adapted to store related data, which can be retrieved, processed, updated, modified or otherwise manipulated. Data table 400 is adapted to store questions that are presented to a subscriber, or user. The user provides answers to the questions, as well as a desired answer representing how they would like another person, group or institution to answer the question as well as a weighing factor, that represents how important the desired answer is from the terminal 110. Data table 400 is discussed in more detail in relation to FIG. 4.

Memory 304 also includes data table 500, which is adapted to store questions, answers, desired answers and a weighing factor for each desired answer from a second user, subscriber, group or institution. The data is typically retrieved by the client terminal 110 from a remote location. Data table 500 is discussed in more detail in relation to FIG. 5. Data table 600 is adapted to store compatibility results as a function of processing the data stored in data tables 400 and 500 and, optionally data retrieved from one or more remote locations. Data table 600 is discussed in more detail in relation to FIG. 6.

Input module 330 is, for example, a keyboard, mouse, touch pad, menu having soft-keys or other input facility adapted to provide input to terminal 110.

Display module 340 is, for example, a monitor, LCD (liquid crystal display) display, GUI (graphical user interface) of other interface facility that is adapted to provide or display information to a user.

FIG. 4 illustrates a data table 400 used to store data related to a first user and reflects input from a first user. The first user may be attempting to find another individual for a personal relationship (dating), a college or university (education), an interest group for a hobby, political cause, charity, or other group (interest group). Data table 400 includes a plurality of questions 402, a plurality of answers 404, a plurality of desired answers 406 and a weighing factor 408 for each question. Specific questions are shown as 402(a) . . . (n) (where “n” is any suitable number) and the corresponding answer is identified as 404(a) . . . (n), respectively. Furthermore, a desired answer for each question is also provided by the first user, as shown by 406(a) . . . (n). A weighing factor 408(a) . . . (n) is associated, or correlated, to each desired answer.

A plurality of questions is presented to users. Each question typically begins with a (1) question stem and (2) possible answers. A sample question might be:

How messy are you?
1. very messy
2. average
3. very organized

The present invention provides an accurate compatibility indication because, rather than simply asking each user to specify his or her response to this question, the present invention asks the user to identify not only a response to the question, but also the optimal response that he/she would like his/her match to respond.

How messy are you?
1. very messy
2. average
3. very organized

Your answer: [1] [2] [3] How you would like your match to answer this question: [1] [2] [3]

This feature of the present invention allows a “very messy” person to specify that she desires a “very organized” partner—or, on the contrary, a fellow “very messy” person. Thus, an accurate compatibility indication is generated because the feature, characteristics and/or attributes that are desired are identified. The user can specify a range, or set of answers that would be acceptable in a potential “match”. For example, a user may indicate that while they may answer the question as average (a “2”) other acceptable answers from another could include a “2” or “3”, indicating that the user desires someone at least as neat as they are; but someone “very organized” would also be equally acceptable.

Furthermore, the present invention assesses relative importance. For example, the question “how messy are you?” may or may not be as important in predicting compatibility as a question such as “what are your religious beliefs?” While most people might find religious beliefs to be more important, there certainly might be people who believe that the practicalities of day-to-day life require that compatibility in “messiness” is actually more important. Thus, by obtaining both the user's response and an ideal response, each user ranks the importance of each question answered:

How important is this question to you:
Irrelevant
A little important
Somewhat important
Very important
Mandatory

Each importance level is assigned a point value. For example:
Irrelevant=0 points
A little important=1 point
Somewhat important=10 points
Very important=50 points
Mandatory=250 points

A second question could be “have you ever cheated in a relationship?”
1 is “yes”
2 is “no”

Specifically, as shown in FIG. 4, question 402(a), “are you messy” is answered by user 1 with a “3”, as shown by 404(a). The desired answer of “2 or 3” is indicated as 406(a) and the weighing factor is “very important”, which has weight of 50 points, as indicated by 408(a).

Data for a second question, “have you ever cheated” 402(b) is answered as “2”, 404(b) and a desired response of “2” is shown as 406(b). The question is rated as having “little importance” and assigned a weight of 1, as shown in 408(b). The list of questions, generally 402, continues until the last question, shown as 402(n) has been answered. This question pertains to education and the answer, desired answer and weight are shown as 404(n), 406(n) and 408(n), respectively.

The present invention is adapted to assign a numerical value to the weighing factor to account for the relative importance of some questions. For example, a user can ascribe, based on their feelings, how heavily weighted, or significant a question is to them. For example, one user may weigh a question such as, “what are your religious convictions?” higher than a question such as, “what flavor ice cream do you like?” However, another user may use a completely different weighting for the same questions. The weights can be represented as a numerical quantity, such as a percentage, decimal, real number, scale or other quantitative term. Alternatively, the weights can a phrase, such as “high”, “medium” or “low”, or a combination of a quantitative terms and qualitative terms.

Furthermore, a user may also specify additional relative levels for a response. For example, a user may weigh a “yes” answer to the question, “are you a vegetarian?” with the highest weight (reflecting that the question is extremely important) and also provide a question, having less weight, such as, “do you eat fish?” A third question, with less weight than the second could be, “do you eat only fish and chicken?” Thus, a candidate who answers that they are a vegetarian will receive a higher score than a candidate who answers “yes” to the fish question. Thus, the present invention accounts for similarities of a desired response that do not exactly match the desired response.

Data table 400 can be stored at server 102, user terminal 110, or other local or remote location and accessed by the server 102 or user terminal 110 by retrieving, downloading, or receiving user input at the server 102, user terminal 110, a local location or a remote location.

FIG. 5 illustrates a data table 500 used to store data related to a second user. Data table 500 is similar to the data table shown in FIG. 4, except that it is populated with input from a second user, or group that is attempting to determine an individual or group that he/she/they may be compatible. Data table 500 includes a plurality of questions 502, a plurality of answers 504, a plurality of desired answers 506 and a weighing factor 508 for each question. Specific questions are shown as 502(a) . . . (n) (where “n” is any suitable number) and the corresponding answer is identified as 504(a) . . . (n), respectively. Furthermore, a desired answer for each question is also provided by the second user, as shown by 506(a) . . . (n). A weighing factor 508(a) . . . (n) is associated, or correlated, to each desired answer.

Thus, referring to the examples of questions shown in FIG. 5, question 502(a), “are you messy” is answered as “2”, as shown by 504(a). The desired answer of “2” is indicated as 506(a) and the weighing factor is “very important”, which has an associated weight of 50 points, as indicated by 508(a). Thus, when compared to the answers provided by the first user, it is evident that although the first user and the second user provided different answers to the first question, the desired answer for the first and second users match. However, the relative weighting of the first user and second user differ. All of the above is used to determine a score, or ratio, or indication, for the particular question. This process is repeated for each question in table 500. A more detailed example is provided in relation to the discussion of FIG. 6.

FIG. 6 illustrates a table 600 that is used to store compatibility indication data. The compatibility indication data is generated by using the first user data of table 400, the second user data of table 500, additional data, if available, which may include predetermined criteria and/or user profile, and one or more algorithms, as discussed herein.

As shown in FIG. 6, data table 600 has a question area 602, a first user area 604 and a plurality of other users 606(a) . . . (n) (where “n” is any suitable number). The number of other users, generally 606, is a function of individuals, or groups, that have provided data. Sum column 609 stores summation data for all possible points for questions answered and all “earned” points for questions answered. First ratio column 610 stores values to determine a ratio of how “satisfactory” a second user's responses were to a first user. Second ratio column 612 stores values to determine a ratio of how “satisfactory” a first user's responses were to a second user. Compatibility indication data is shown in column 680. This compatibility indication data may be calculated as a function of the first and second ratios or may also include predetermined criteria 681, user profile data 683, a margin of error component, and a ranking component.

Thus, from the example above, user 1 and user 2 both answered question 1 and question 2. Common questions that were answered by various users are used to compute an indication of compatibility.

In calculating the compatibility indication data between any two users, a determination is made to ascertain a level of compatibility of a second user to a first user and a level of compatibility of a first user to a second user. Thus, a level of compatibility for user 1 and user 2 for commonly answered questions is determined by two ratios. The first ratio is how acceptable user 1 found responses by user 2 and a second ratio of how acceptable user 1 was determined by user 2.

(1) A Level of Compatibility of the Second User to the First User:

A first user can indicate that the second user's answer to the first question was very important, while the answer to the second question was not. For example user 1 responded to question 1, “are you messy”, such that the weight was assigned a point value of 50, shown as element 652. (See also, FIG. 4 element 408(a)) The response for question 2, “have you ever cheated” was calculated, by user 1, to have a point value of 1, shown as element 664. (See also, FIG. 4 element 408(b)) Since user 2 provided a fully credited response to question 1, user 2 had a score of 50 for question 1, shown as element 654. (See FIG. 5, elements 504(a) and 506(a)) User 2 obtained a score of zero for question 2 (element 666) since user 2 answered question 2 with a “1” (FIG. 5, element 504(b)) and user 1 desired a response of “2” (FIG.4, element 406(b)). Thus, of those 51 possible points (element 682, which is the sum of element 652 plus element 664) of “satisfaction”, the second user earned 50 points (element 684) by answering the first question (element 654) in the manner the first user requested (50 points) and zero for the response user 2 provided to question 2 (element 666). So the second user's answers were 50/51=98% satisfactory (element 685).

(2) A Satisfaction Level of the First User's Response to a Second User:

A second user may have placed little importance on the first user's answer to the first question and a little bit more on the second. This is shown by 1 point for question 1 (element 656) and 10 points for question 2 (element 668). Of those 11 points of weight (element 690), the first user earned 10 points (element 688; 10 points for question 1, shown as element 653, and zero for question 2, shown as element 665). So the first user's answers were 10/11=91% satisfactory (element 691).

The compatibility indicator data for the first and second user is calculated by multiplying the two satisfaction rates (0.98 and 0.91) and then calculating the square root of the product: SQRT(0.91*0.98)=0.94 (element 696).

Also, as shown in FIG. 6, user n and user 1 both answered question 1 and question 2. User 1 had a score of 50 points (632) for question 1 and 1 point (634) for question 2 for a total of 51 points (692). User n earned 40 total points for questions 1 and 2 (658) (40 points, shown as element 674 and zero points, shown as element 640). Thus, the ratio for question 1 is 40/51 (element 671). Similarly, user 1 earned 11 total points (element 672; 10 points, shown as element 676 plus 1 point, shown as element 642). User n had a score of 11 points (element 670; 10 points, shown as element 630 plus 1 point, shown as element 636). Thus, the ratio between user 1 to user n was 11/11=1.0 (element 673). Thus, the compatibility ratio is the square root of the product of the ratios, which is SQRT ( 40/51* 11/11), or 0.88 (shown as element 698).

Thus, the scoring process described in relation to question 1 and question 2 is performed for each question, which has a response for both users that are being compared. Questions that both users did not answer are not used as a basis of compatibility.

While the compatibility indication data is a function of the ratios, the compatibility indication data may also be a function of predetermined criteria 681, profile data 683, include a ranking 868 as well as a margin of error 687.

Predetermined criteria 681 may include preferences that are given priority over matching ratios. Such criteria may include, for example, gender preferences, religious preferences, age, height and weight preferences, and income preferences. Thus, if the predetermined criteria are not met, a ratio will not be generated. Furthermore, the compatibility indication data will reflect the number of criteria that are met. This can be reflected in the ranking process. The predetermined criteria prevent users from being matched with other users that do not satisfy minimum criteria (e.g., age, gender or religion).

Another example of predetermined criteria is that questions having the maximum weight are deemed mandatory and users that do not respond to each other's mandatory questions will not be matched with each other. Alternatively, failure of users to respond to each other's mandatory questions could lower the compatibility indication. As shown in FIG. 6, predetermined criteria 681 includes “all met” indicator and (400), shown generally as element 622. This means that all questions rated as “mandatory” and other required information, such as gender and religion were met by user 1 and user 2. The 400 indicates that the S-value for user 1 and user 2 was 400 questions answered. (See below for a further discussion of the S-value.) For user n, all the predetermined criteria were also “all met” and user 1 and user n have an S-value of 300, as shown in element 623. Furthermore, referring back to FIGS. 4 and 5, questions 402(n) and 502(n) were different for user 1 and user 2 so those questions (402(n) and 502(n)) were not used. If either of those questions had been indicated by user 1, or user 2, as mandatory, the failure for both to answer would have resulted in user 1 and user 2 being deemed incompatible for failure to meet predetermined criteria.

The user profile data 683 can also be used to modify the ranking of users. As shown in FIG. 6, user 2 had a profile rating of 2, 6 and 8, shown as element 624. These numbers reflect that user 2 may enjoy the outdoors, is typically not on the computer network during weekdays and is rated as a lengthy user of the network. Similarly, user n matches numbers 2 and 8, as shown by element 628. User profile data 683 may include specific information provided by a user as well as passive information, which is discussed in more detail in relation to FIG. 8.

Also, optionally, the accuracy of match percentage (680) can be increased by taking into consideration the number of questions that users have answered in common.

For example, two users might have a high match percentage after only answering one question in common, the present invention takes into account the size of the set of questions the two users have answered. As long as this set of questions is small, the confidence level of the match percentage is correspondingly low.

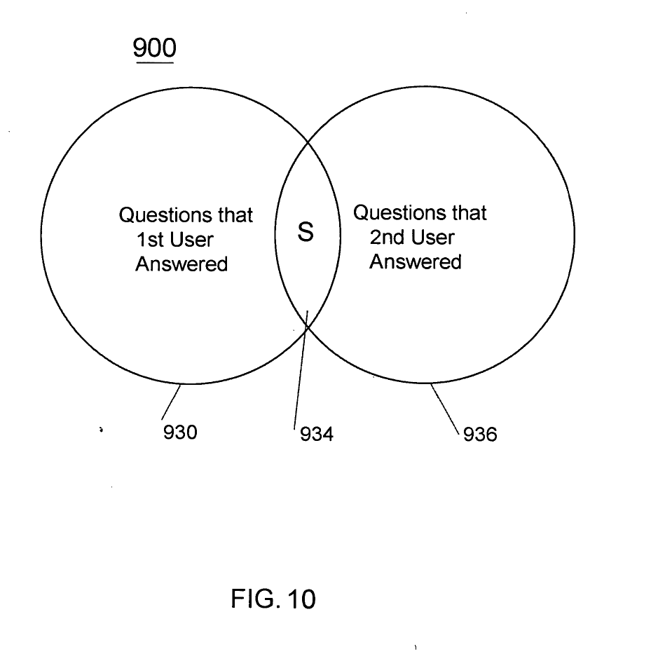

Specifically, a further level of compatibility indication can be calculated as the match percentage less a margin of error, shown as element 617. The margin of error is 1/sqrt(S), (element 621) where S (element 934, also discussed in relation to FIG. 10) is the number of questions the two users answered in common. For example, if user 1 and user 2 have answered 400 of the same questions, and their raw match percentage is 94%, the margin of error is calculated to be 1/sqrt(400)=5%. Using the lower bound of this range as the further level of compatibility indication, which in this case would be 89%. Similarly, user 1 and user n answered 300 of the same questions, and their raw match percentage is 88%, the margin of error is calculated to be 1/sqrt(300)=5.78%. Using the lower bound of this range as the further level of compatibility indication, which in this case would be 82%.

The ranking 686 is used to indicate an order, or rank, of matches for each user. This rank can be a function of the ratio and other data, as well as a margin of error. As shown in FIG. 6, user 2 was ranked “1” (element 697) and user n was ranked “2” (element 699).

FIGS. 7A and 7B show an algorithm 700 used to generate the compatibility indication data. The algorithm starts with start step 702. Users are registered in step 704 and the registered user logs on at step 706. Responses to questions are obtained from the first user at step 708. Desired responses are obtained from the user in step 710. Weighing data is obtained for the question in step 712. The answer, desired answer and weighing, or representations thereof, are stored in step 714. Step 715 calculates a score for the question by associating an answer with each question and multiplying the question by the weighing factor. Decision step 716 determines whether there are additional questions. If so, “yes” line 718 leads to step 708. If not, “no” line 720 leads to step 721, which performs a summation operation for every question answered. (The first user data obtained as described above may be stored, for example, in a data table as shown in FIG. 4.)

Step 722 obtains answers to questions from a second user. Desired responses are obtained from the second user in step 724. Weighing data is obtained for the question in step 726. The answer, desired answer and weighing, or representations thereof, are stored in step 728. Step 729 calculates a score for the question by associating an answer with each question and multiplying the question by the weighing factor. Decision step 730 determines whether there are additional questions. If so, “yes” line 732 leads to step 722. If not, “no” line 731 leads to step 734, which performs a summation operation for every question answered by the second user. (The second user data obtained as described above may be stored, for example, in a data table as shown in FIG. 5.)

Step 735 assigns a rating for the user profile for user 2. This is typically passive data, as described in relation to FIG. 8. This passive data can be assigned a numerical value and incorporated into the factoring step 740.

Step 736 sums all possible points for question data provided by user 1 and user 2 and all earned points by user 1 and user 2 are summed in step 737.

In calculating the match percentage between any two people, a determination is made to ascertain:

(1) a level of compatibility of the second user to the first user.

(2) a satisfaction level of the first user's response to a second user.

The calculation includes generating a first ratio and a second ratio, as shown in step 738. The first ratio is determined by comparing the number of points user 1 assigned the answered questions and the number of points user 2 earned by providing responses that corresponded to desired responses of user 1. The second ratio is determined by comparing the number of points user 2 assigned the answered questions and the number of points user 1 earned by providing responses that corresponded to desired responses of user 2.

Step 739 calculates a compatibility indication by calculating: SQURT( (ratio1)*(ratio2)). This quantity can be modified by a margin of error, profile data, predetermined criteria and ranked based on the ratio or any permutations of modification factors, step 740.

Decision step 742 determines whether there are additional users. If so, “yes” line 743 leads to step 722, which initiates the response process again. This process is repeated for all users who wish to participate.

If decision step 742 determines that there are no more users, “no” line 744 leads to step 746, which sorts the matching ratios calculated. Step 748 outputs the results of the sorting process, which may be to one or more user locations or a storage location. End step 749 ends the algorithm.

FIG. 8 illustrates a table 800 used to generate a user profile of a user. The data stored in table 800 represents passive information obtained about a user. The passive information can be combined with non-passive information. The non-passive information is typically affirmative data provided by a user and typically includes information such as, for example, age, gender, height, weight, hair color, likes and dislikes and other information that is expressly provided by the user. However, passive information includes information about a user that is not expressly provided, but which is obtained through monitoring activities and/or accumulating unrelated, random or non-obvious information.

As shown in FIG. 8, a time of day that a user logs on to the network can be stored in area 810. For example, user 2 is shown to typically log onto the network (Internet) at 10:30 p.m. Other web sites, or data retrieved by the user can be stored in area 812. These include, for example, LL Bean and Wilderness World. The duration of the session is stored in area 814 and extra data, such as key words used to search the network can be stored, as shown by element 816. The passive information can be accumulated to generate a user profile 820. For example, user 2 has items 2, 6 and 8 highlighted, which may indicate that user 2 does not log on until after 10:00, is interested in the outdoors and has an average connection session that exceeds 5 hours. This user profile can be compared to other user profiles to determine compatibility.

FIG. 9 shows an algorithm 750 to generate compatibility indication data at a user location. This algorithm may be retrieved from a remote location, and stored and/or executed at a user terminal, such as terminal 110, discussed previously. The algorithm begins with start step 752. A user accesses question data in step 754. This question data is typically a plurality of questions, each having a question stem and possible responses. The user provides response data, as shown in step 756, desired response data, as shown in step 758, and a weighing factor for each response and/or desired response, as shown in step 760.

Step 762 shows that the user receives indication data that indicates a compatibility rating for other users. This compatibility ratio is generated according to the algorithm described herein. The actual calculation may be performed at a remote location, such as server 102 or at the user terminal if the user terminal has access to the algorithm. The access may be that the algorithm is stored at the user terminal or input from a peripheral memory device such as a CD-ROM, floppy disk or other medium. Step 764 ends the algorithm.

FIG. 10 shows a diagram 900 of compatibility. A pool of questions answered by the first user is shown as circle 930. The pool of questions answered by a second user is shown as circle 936 and the overlap, “S-value”, is shown as area 934. The questions can be generated by a third party or can be supplied by users. This latter option further increases the likelihood that a user can customize the questions to his/her needs. Moreover, this customized approach is not based on any preconceived notion of compatibility.

The above-described example can be used with additional users and a rating can be generated using the algorithm. Furthermore, a sorting process can rank the users as a function of the compatibility determination. This ranking can be provided to the users to illustrate other users and the relative compatibility rating.

A further embodiment of the present invention may include written text, provided by a user, describing their interests and likes and dislikes, and these textual files are searched using a keyword search to determine the compatibility. For example, if particular words are used by a first user and a second user, the frequency of the match can be used in determining the compatibility ratio. The information obtained from analysis of the key words provided in the written text could used as a component of the user profile, generated as described in relation to FIG. 8. The written text feature may be automated using computer software to parse the text or may be used by a human operator to obtain greater insight into a person prior to providing matching data to one or more users.

It is contemplated that some of the process steps discussed herein as software processes may be implemented within hardware, for example as circuitry that cooperates with the processors to perform various steps.

Thus, while fundamental novel features of the invention shown and described and pointed out, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in another form or embodiment. It is the intention, therefore, to be limited only as indicated by the scope of the claims appended hereto.

What is claimed is:

1. A method for generating an indication of compatibility comprising:
accessing first response data from a first user;
accessing desired first response data from the first user;
associating a first weighing factor with each of the desired first response data;
accessing second response data from a second user;
accessing desired second response data from the second user;
associating a second weighing factor with each of the desired second response data; and
generating indicator data as a function of the first response data, first desired response data, first weighing factor, the second response data, the second desired response data, and the second weighing factor.

2. The method as claimed in claim 1, further comprising storing the indicator data.

3. The method as claimed in claim 1, wherein the step of generating indicator data further comprises calculating a square root of a product of two ratios.

4. The method as claimed in claim 1, further comprising:
sorting the indicator data as a function of predetermined criteria.

5. The method as claimed in claim 4, wherein the predetermined criteria is accessed from one or more remote locations.

6. The method as claimed in claim 4, further comprising:
transmitting at least a portion of the indicator data to a location selected by the first user, as a function of the predetermined criteria.

7. The method as claimed in claim 1, further comprising:
obtaining additional information related to one or more users; and
utilizing the additional information in the step of generating indicator data.

8. The method as claimed in claim 7, wherein the additional information is a function of a user profile.

9. The method as claimed in claim 8 further comprising:
associating one or more users that have corresponding user profiles.

10. The method as claimed in claim 1, wherein the first response data and the desired first response data relate to one or more educational institutions.

11. The method as claimed in claim 1, wherein the first response data and the desired first response data relate to one or more employment situations.

12. A method for generating an indication of compatibility comprising:
providing a user interface to a first user to receive first response data from the first user;
providing the user interface to the first user to receive desired first response data from the first user;
providing the user interface to the first user to receive a first weighing factor from the first user; and
receiving, at a user location, indicator data as a function of the first response data, first desired response data, the first weighing factor, second response data, second desired response data, and second weighing factor.

13. The method as claimed in claim 12, further comprising storing the indicator data.

14. The method as claimed in claim 12, further comprising transmitting the indicator data to a remote location.

15. The method as claimed in claim 12, further comprising:
sorting the indicator data as a function of predetermined criteria.

16. The method as claimed in claim 12, further comprising:
transmitting at least a portion of the indicator data to a location selected by the first user, as a function of the predetermined criteria.

17. The method as claimed in claim 12, further comprising:
obtaining additional information related to one or more users; and
utilizing the additional information in the step of generating indicator data.

18. The method as claimed in claim 17, wherein the additional information is a function of a user profile.

19. The method as claimed in claim 18 further comprising:
associating one or more users that have corresponding user profiles.

20. An apparatus for generating an indication of compatibility comprising:
means for accessing first response data from a first user;
means for accessing desired first response data from the first user;
means for associating a first weighing factor with each of the desired first response data;
means for accessing second response data from a second user;
means for accessing desired second response data from the second user;
means for associating a second weighing factor with each of the desired second response data; and
means for generating indicator data as a function of the first response data, first desired response data, first weighing factor, the second response data, the second desired response data, and the second weighing factor.

21. The apparatus as claimed in claim 20, further comprising means for storing the indicator data.

22. The apparatus as claimed in claim 20, further comprising means for transmitting the indicator data to a remote location.

23. The apparatus as claimed in claim 20, further comprising:
means for sorting the indicator data as a function of predetermined criteria.

24. The apparatus as claimed in claim 23, wherein the predetermined criteria are accessed from one or more remote locations.

25. The apparatus as claimed in claim 23, further comprising:
means for transmitting at least a portion of the indicator data to a location selected by the first user, as a function of the predetermined criteria.

26. The apparatus as claimed in claim 20, further comprising:
means for obtaining additional information related to one or more users; and
utilizing the additional information in the step of generating indicator data.

27. The apparatus as claimed in claim 26, wherein the additional information is a function of a user profile.

28. An apparatus for generating an indication of compatibility comprising:
means for receiving first response data from a first user;
means for receiving desired first response data from the first user;
means for receiving a first weighing factor from the first user; and
means for receiving, at a user location, indicator data as a function of the first response data, first desired response data, the first weighing factor, second response data, second desired response data, and second weighing factor.

29. The apparatus as claimed in claim 28, further comprising means for storing the indicator data.

30. The apparatus as claimed in claim 28, further comprising means for transmitting the indicator data to a remote location.

31. The apparatus as claimed in claim 28, further comprising:
means for sorting the indicator data as a function of predetermined criteria.

32. The apparatus as claimed in claim 28, further comprising:
means for transmitting at least a portion of the indicator data to a location selected by the first user, as a function of the predetermined criteria.

33. The apparatus as claimed in claim 28, further comprising:
means for obtaining additional information related to one or more users; and
utilizing the additional information in the step of generating indicator data.

34. The apparatus as claimed in claim 28, wherein the additional information is a function of a user profile.

35. A series of steps stored on a computer-readable medium for generating an indication of compatibility comprising:
program code for accessing first response data from a first user;
program code for accessing desired first response data from the first user;
program code for associating a first weighing factor with each of the desired first response data;
program code for accessing second response data from a second user;
program code for accessing desired second response data from the second user;
program code for associating a second weighing factor with each of the desired second response data; and
program code for generating indicator data as a function of the first response data, first desired response data, first weighing factor, the second response data, the second desired response data, and the second weighing factor.

36. The method as claimed in claim 35, further comprising program code for storing the indicator data.

37. The method as claimed in claim 35, further comprising program code for transmitting the indicator data to a remote location.

38. The method as claimed in claim 35, further comprising:
program code for sorting the indicator data as a function of predetermined criteria.

39. The method as claimed in claim 38, further comprising:
program code for transmitting at least a portion of the indicator data to a location selected by the first user, as a function of the predetermined criteria.

40. The method as claimed in claim 35, further comprising:
program code for obtaining additional information related to one or more users; and
utilizing the additional information in the step of generating indicator data.

41. The method as claimed in claim 40 further comprising:
program code for associating one or more users that have corresponding user profiles.

42. A method for generating an indication of compatibility comprising:
program code for receiving first response data from a first user;
program code for receiving desired first response data from the first user;
program code for receiving a first weighing factor from the first user; and
program code for receiving, at a user location, indicator data as a function of the first response data, first desired response data, the first weighing factor, second response data, second desired response data, and second weighing factor.

43. The method as claimed in claim 42, further comprising program code for storing the indicator data.

44. The method as claimed in claim 42, further comprising program code for transmitting the indicator data to a remote location.

45. The method as claimed in claim 42, further comprising:
program code for sorting the indicator data as a function of predetermined criteria.

46. The method as claimed in claim 45, further comprising:
program code for transmitting at least a portion of the indicator data to a location selected by the first user, as a function of the predetermined criteria.

47. The method as claimed in claim 42, further comprising:
program code for obtaining additional information related to one or more users; and
utilizing the additional information in the step of generating indicator data.

48. The method as claimed in claim 47, wherein the additional information is a function of a user profile.

49. The method as claimed in claim 48, further comprising:
program code for associating one or more users that have corresponding user profiles.
